(19) United States
(12) Patent Application Publication
(10) Pub. No.: US 2026/0370952 A1
(43) Pub. Date: Nov. 19, 2026

(54) Apparatus and Method for Determining a Reduced Transparency of a Window of a Vehicle

(71) Applicant: Bayerische Motoren Werke Aktiengesellschaft, Muenchen (DE)

(72) Inventors: Vincent Karas, Muenchen (DE); Johannes Feldmaier, Ebersberg (DE); Andreas Menath, Muenchen (DE); Fabian Franke, Muenchen (DE); Carina Weismann, Muenchen (DE); Willibald Watzka, Kuehbach (DE)

(21) Appl. No.: 19/126,021

(22) PCT Filed: Aug. 16, 2023
(86) PCT No.: PCT/EP2023/072547

§ 371 Date: Apr. 30, 2025

(30) Foreign Application Priority Data
Nov. 15, 2022 (DE) 10 2022 130 167.2

(51) Int. Cl. H04N 23/71; B60Q 1/24; G06V 20/59; H04N 23/74; H04N 23/90

(52) U.S. Cl. CPC H04N 23/71; B60Q 1/249; G06V 20/59; H04N 23/74; H04N 23/90

(57) ABSTRACT

An apparatus for determining a reduced transparency of a window of a vehicle includes first and second image sensors, and an evaluation device. The first image sensor captures a first image of a spatial area outside the vehicle through a window of the vehicle. The second image sensor captures a second image of the spatial area, other than through the window of the vehicle. The evaluation device has an algorithm configured to determine, by comparing the first image with the second image, whether the window has a reduced transparency in comparison with a reference value.

The present application is the U.S. national phase of PCT Application PCT/EP2023/072547 filed on Aug. 16, 2023, which claims priority of German patent application No. 10 2022 130 167.2 filed on Nov. 15, 2022, the entire contents of which are incorporated herein by reference.

### TECHNICAL FIELD

The present disclosure relates generally to the field of vehicles, and more specifically, to determining a reduced transparency of a window of a vehicle.

### BACKGROUND

In a vehicle, visibility through a window can be limited due to misting, in particular as a result of frost formation or condensed water vapor. This can have a negative impact, in particular, for a driver while driving the vehicle, since the driver can no longer see a traffic situation through a misted-up window, or can only see it to a limited extent.

To determine whether there is misting and therefore the transparency of the window is reduced, solutions are known in which temperature sensors, humidity sensors and/or special mist sensors are used to determine such limitations in visibility. These solutions are complex since they require appropriate sensors on the vehicle. In addition, such sensors can only record measurements at individual positions where the respective sensor is arranged. Moreover, the sensors are used to identify measured values which are only indirectly related to a reduced transparency of the window, which means that an evaluation is additionally required here in order to determine how the recorded measured values lead to a reduced transparency.

There is a need, therefore, to improve determination of a reduced transparency of a window of a vehicle.

### SUMMARY

The above-described need, as well as others, are addressed by at least some of the embodiments described herein.

A first aspect relates to an apparatus for controlling a system of a vehicle, having: (i) A first image sensor which is configured to capture a first image of a spatial area outside the vehicle through a window of the vehicle; (ii) a second image sensor which is configured to capture a second image of the spatial area, wherein this capture does not take place through the window of the vehicle; (iii) an evaluation device which has an algorithm that is configured to determine, by comparing the first image with the second image, whether the window has a reduced transparency in comparison with a reference value.

Furthermore, “or”, unless expressly stated to the contrary, refers to an inclusive or and not to an exclusive “or”. For example, a condition A or B is met by one of the following conditions: A is true (or present) and B is false (or not present), A is false (or not present) and B is true (or present), and both A and B are true (or present).

The terms “a” or “one”, as used here, are defined in the sense of “one or more”. The terms “another” and “a further” and any other variants thereof are to be understood in the sense of “at least one further”.

The term “plurality”, as used here, is to be understood in the sense of “two or more”.

The term “configured” or “set up” to fulfil a certain function, (and respective variations thereof) as used here, is understood to mean that the corresponding apparatus is already present in a configuration or setting in which it can perform the function or it at least can be set—i.e. can be configured—in such a way that it can perform the function after being set appropriately. The configuration can take place, for example, by appropriately setting parameters of a process sequence or switches or similar to activate or deactivate functionalities or settings. In particular, the apparatus can have several predetermined configurations or operating modes, such that the configuring can take place by selecting one of these configurations or operating modes.

The term “image sensor”, as used here, is to be understood in particular as a sensor that is designed to detect or measure electromagnetic signals and convert them into electrical signals. These sensors can be in particular a charge-coupled sensor, also known as a CCD (Charge-Coupled Device), which can detect electromagnetic signals which are in particular visible and invisible to the human eye, a radar sensor, a Lidar sensor, or another sensor. In addition, such a sensor can also be designed to emit electromagnetic signals to an object, and to in turn measure the electromagnetic signals reflected back from this object, so that, in a subsequent evaluation, information regarding the object can be obtained from the emitted and reflected-back electromagnetic signals, also known as a TOF (Time-of-Flight) camera.

The term “window”, as used here, is to be understood in particular as a window of a vehicle with a movable windowpane, such as a side window, or a window with a permanently installed and immovable windowpane, such as a windshield or a rear window.

By means of the apparatus according to the first aspect, the following can be achieved: a transparency, which is reduced in comparison with a reference value, of a window of a vehicle can be determined by image comparison of a first image with a second image. The reference value can relate in particular to the transparency of a factory-new window or a windowpane. The reference value can also be determined by means of a reference measurement of the window or the windowpane in the vehicle, if the window does not have a reduced transparency. In this case, the first and/or the second image sensor can have a camera in particular. The first image sensor, in particular, an interior camera, captures a spatial area through the window. Correspondingly, the window is arranged between the spatial area to be captured and the first image sensor. The second image sensor, in particular, a camera arranged in an outer area of the vehicle, also captures the spatial area. In this case, the window is not arranged between the spatial area and the second image sensor. An interior camera and a further camera, in particular, a camera for parking assistance, may already be arranged in modern motor vehicles. These cameras can be used to capture the first and second image. Using the cameras already present in the vehicle saves employing additional sensors for capturing measurement variables, such as temperature and humidity, to determine whether the window has a reduced transparency. The sensors mentioned can be used to detect measurement signals by means of which conclusions can be made possible regarding a reduced transparency. According to the present solution as claimed in claim 1, however, a transparency can be identified directly by comparing the first image with the second image. As a result, a reduced transparency can be identified more reliably.

Hereinafter, exemplary embodiments of the apparatus will be described which in each case, unless this is expressly excluded or is technically impossible, can be combined with one another and with the other further aspects described, as desired.

In some embodiments, the apparatus has a control device which is configured to control the first image sensor and the second image sensor in such a way that the first image is captured substantially at the same time as the second image. As a result, reliability when determining the reduced transparency can be improved, because this means that changes, over time, in the transparency and also changes in conditions during the captures, such as light conditions, between the capture of the first image and the capture of the second image are virtually ruled out.

In some embodiments, the control device is configured to activate, before the first image or second image is captured, a vehicle lighting system of the vehicle by means of which the spatial area can be illuminated. This means that capture of the first image and of the second image of the spatial area can take place in improved light conditions. This means that it can be identified in an improved manner whether the window has a reduced transparency in comparison with a reference value. A light cone itself produced by the vehicle lighting system can also be used as part of the evaluation. In this case, the light cone can appear blurred or low-contrast in the first image, because it was captured through the window, and higher-contrast in the second image. A comparison of the brightness of the light cone in the first image with the brightness of the light cone in the second image can also be carried out as part of the evaluation, in order to determine whether there is reduced transparency.

In some embodiments, the control device is configured to activate the vehicle lighting system if a lighting intensity, identified by a sensor arranged on the vehicle, in the surroundings of the vehicle has fallen below a prescribed threshold value. As a result, it can be ensured that the spatial area is illuminated when the first image and second image are captured at dusk or at night. This means that an improved image quality of the first image and of the second image can be achieved. As a result, this means that it can be determined, even in low light conditions, whether there is a reduced transparency in comparison with a reference value.

In some embodiments, the apparatus furthermore has: (i) a system with an operating mode in which the transparency can be increased; (ii) and a control device which is configured to activate the operating mode of the system if the comparison has revealed that the window has a reduced transparency in comparison with the reference value. By increasing the transparency, a driver of the vehicle can see a traffic situation more easily through the window, with the result that driving safety can be increased.

In some embodiments, the algorithm of the evaluation device is configured to determine, from a plurality of first images captured temporally one after another and from a plurality of second images captured temporally one after another, in each case by comparing in each case one of the first images with in each case one of the second images, whether the window has a reduced transparency in comparison with the reference value; wherein the control device is configured to deactivate the operating mode of the system if one of the comparisons has revealed that the transparency substantially corresponds to the reference value. This means that deactivation of the operating mode can take place in an automated manner, if one of the comparisons has revealed that there is no longer a reduced transparency. This can lead to a saving of energy in the vehicle, because the operating mode of the system is only activated as long as there is a reduced transparency.

In some embodiments, the system has a heating device, wherein the control device is configured to activate an operating mode of the heating device in which heat for heating the window is generated by the heating device. The heating device can heat an interior of the vehicle by means of the generated heat via an air exchange, and thereby heat the window of the vehicle, with the result that an increase in transparency is made possible. The heating device can also have a heating wire which is integrated in the window, in particular a rear window, with the result that the rear window is heated from within the rear window. This has the advantage that misting of the window both on the inner side and on the outer side can be reduced, and the transparency of the rear window can be increased in an overall improved manner.

In some embodiments, the system has a windshield-cleaning device with a windshield wiper and a cleaning-fluid device, wherein the control device is configured to activate an operating mode of the windshield-cleaning device in which the windshield wiper and/or the cleaning-fluid device is activated. This means that the windshield wiper can be activated, with the result that the windshield wiper wipes across the windshield, and the transparency on an outer side of the window can be increased. Furthermore, by activating the cleaning-fluid device, cleaning fluid can be output that flows across the window. This can take place in the case of the windshield and the rear window f the vehicle. By means of the cleaning fluid, misting of the window, which was caused in particular by frost formation, can be reduced. Both the windshield wiper and the cleaning-fluid device can also be activated in parallel, with the result that interaction of the windshield wiper and the cleaning-fluid device for increasing the transparency of the window is made possible. In the process, the windshield wiper can wipe away the cleaning fluid and along with it possible frost formation in an improved manner, and thereby increase the transparency of the window.

In some embodiments, the system has a ventilation device, wherein the control device is configured to activate an operating mode of the ventilation device in which air is supplied to an interior of the vehicle by the ventilation device. This means that misting of the window due to condensed water vapor on an inner side of the window can be reduced. Misting of the window due to frost formation or snow can also be reduced. In this connection, it can be advantageous to additionally heat the supplied air in advance so as to make it possible to reduce the misting more quickly. As a result, by reducing the misting by means of a supply of air in the interior, the transparency of the window can be increased.

In some embodiments, the system has a window regulator, wherein the control device is configured to activate an operating mode of the window regulator in which the window, in particular a side window, is moved into an open state by the window regulator. In the case of a side window, it may be sufficient if the window or the windowpane is moved from the closed state into a partially open state. This means that air can pass from outside the vehicle through the partially open window into an interior of the vehicle. By means of this supply of air from outside the vehicle, the transparency of the window, due to condensed water vapor on an inner side of the window, can be increased.

A second aspect relates to a vehicle having an apparatus according to the first aspect.

A third aspect relates to a method, in particular a computer-implemented method, for controlling a system of a vehicle, with the following steps: (i) capture of a first image of a spatial area outside the vehicle through a window of the vehicle using a first image sensor; (ii) capture of a second image of the spatial area using a second image sensor, wherein this capture does not take place through the window of the vehicle; (iii) comparison of the first image with the second image, taking into account a reference value by means of an algorithm of an evaluation device; (iv) determination, using the comparison, as to whether the window has a reduced transparency in comparison with a reference value.

A fourth aspect relates to a computer program with instructions which cause the apparatus according to the first aspect to perform the steps of the method according to the third aspect.

The computer program can be stored in particular on a non-volatile data carrier. This is preferably data carrier in the form of an optical data carrier or a flash storage module. This may be advantageous if the computer program as such is intended to be sold independently of a processor platform on which the one or more programs are to be executed. In another implementation, the computer program can be present as a file on a data processing unit, in particular on a server, and may be downloadable via a data link, for example the Internet or a dedicated data link such as a proprietary or local network, for example. In addition, the computer program can have a plurality of interacting individual program modules. The modules can, in particular, be configured or in any case can be usable in such a way that they are executed on different appliances (computers or processor units), in the sense of distributed computing, which are geographically distant from one another and are connected to one another via a data network.

The features and advantages explained in relation to the first aspect of the solution also apply correspondingly to the further aspects described.

Further advantages, features and application options can be gathered from the following description in conjunction with the figures.

### BRIEF DESCRIPTION OF THE DRAWINGS

FIG. 1 schematically shows a vehicle with an apparatus according to one embodiment; and

FIG. 2 shows a flowchart to illustrate a preferred embodiment of a method.

### DETAILED DESCRIPTION

Throughout the figures, the same reference signs are used for the same or mutually corresponding elements.

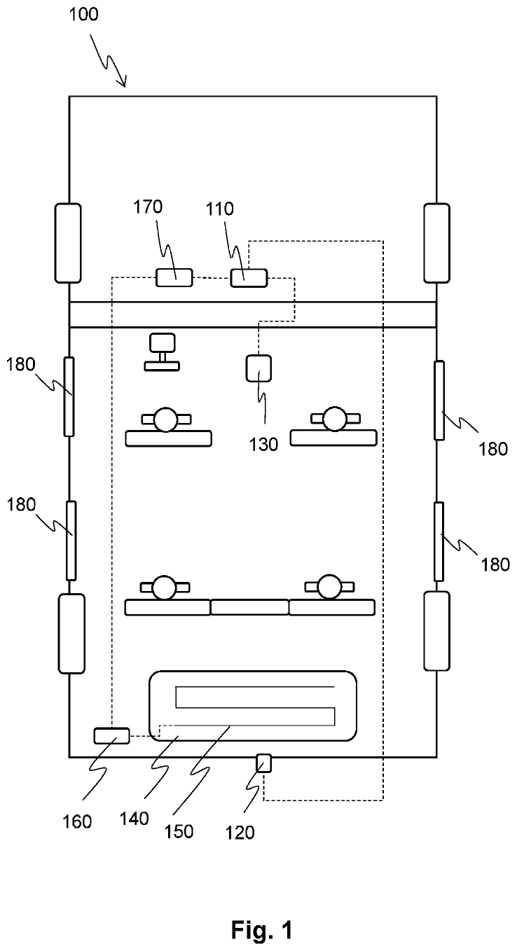

In FIG. 1, a vehicle 100 is shown schematically in a plan view with an apparatus according to one embodiment. The vehicle 100 has an inner camera 130 which can be designed in particular as a wide-angle camera, and an exterior camera 120 which can be designed in particular also as a wide-angle camera. The interior camera 130 is arranged on a headliner (not shown here) of the vehicle 100 in an interior of the vehicle 100. By means of the interior camera 130, a spatial area, which is outside the vehicle 100, and which is visible from the interior of the vehicle 100 through one of the side windows 180, through a rear window 140 or through a windshield (not shown here) of the vehicle 100, can be captured as an image. According to the present embodiment, the spatial area, which is visible through the rear window 140 of the vehicle 100, is taken into account. The exterior camera 120 is arranged on a body of the vehicle (not shown here), in particular a bumper, in the rear area of the vehicle 100. In particular, the exterior camera 120 can already be provided for another assistance system on the vehicle 100, for example for a parking assistance system and/or an assistance system for autonomous driving. The exterior camera 120 can also be used to capture the spatial area as an image. The spatial area is captured directly by the exterior camera 120, that is, without the rear window 140 being arranged between the spatial area and the exterior camera 120.

By means of an algorithm which is contained in an evaluation device 110 of the vehicle 100, the spatial area captured as an image by the interior camera 130 can be compared with the spatial area captured as an image by the exterior camera 120. Available algorithms can be utilized for the image comparison. A reference value is used for determining the reduced transparency. This reference value can relate in particular to the transparency of a factory-new window 140, 180 or a windowpane. The reference value can also be determined by means of a reference measurement of the window 140, 180 or of the windowpane in the vehicle 100, if the window 140, 180 does not have a reduced transparency. There may be reduced transparency on the rear window 140 if the image comparison reveals that the images do not match. From this, it can be determined that the rear window 140 has a reduced transparency. By means of the control device 170, a rear-window heating device 160 can be activated if the comparison has revealed that there is reduced transparency on the rear window 140. As a result, a rear-window wire 150, which is integrated in the rear window 140, has current applied to it and heats up, and correspondingly the rear window 140 heats up.

If the comparison has revealed that there is reduced transparency on the rear window 140, the control device 170 can also be used to activate a windshield wiper and/or a ventilation device of the vehicle 100, so as to reduce misting of an inner side of the window 140, 180 in order to increase the transparency. Furthermore, a window regulator of the vehicle can be activated such that a window 180 is at least partially opened, so as to make it possible to supply air from outside the vehicle 100 in order to reduce misting of an inner side of the window 140, 180, with the result that the transparency can be increased (not shown here).

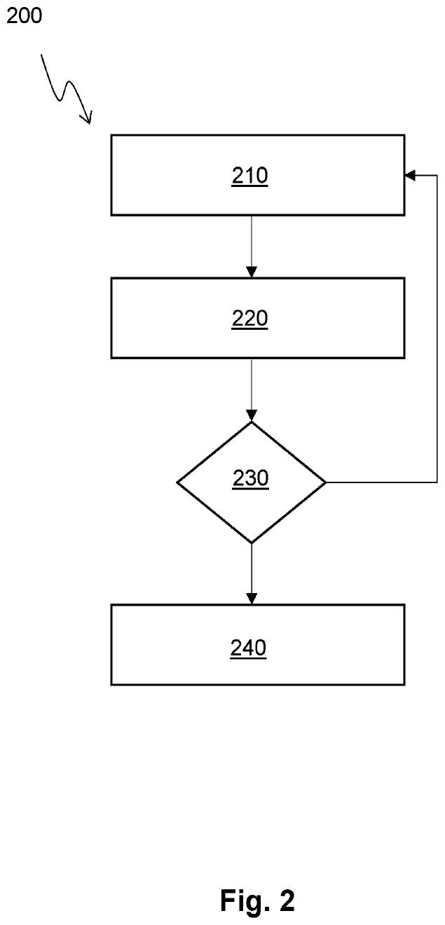

In FIG. 2 a flowchart 200 is shown, to illustrate a preferred embodiment of a method for controlling a system 160 of a vehicle 100.

In a first step 210 of the method, a first image of a spatial area outside the vehicle 100 is captured through a window 140, 180 of the vehicle 100 using a first image sensor 130.

In a further step 220 of the method, a second image of the spatial area is captured using a second image sensor 120, wherein this capture does not take place through the window 140, 180 of the vehicle 100.

In a further step 230 of the method, the first image is compared with the second image while taking into account a reference value by means of an algorithm of an evaluation device 110.

In a further step 240 of the method, the comparison is used to determine whether the window 140, 180 has a reduced transparency in comparison with a reference value.

If the comparison has revealed that the transparency is not reduced, the method begins again with the first method step 210.

While at least one exemplary embodiment was described hereinabove, it should be noted that a large number of variations thereof exist. It should also be considered that the exemplary embodiments described only represent non-limiting examples, and it is not intended thereby to restrict the scope, applicability or configuration of the apparatuses and methods described here. Rather, the preceding description will provide a person skilled in the art with a guide for implementing at least one exemplary embodiment, wherein it is understood that various modifications to the functionality and arrangement of the elements described in an exemplary embodiment can be undertaken, without thereby departing from the subject matter respectively specified in the appended claims and its legal equivalents.

### LIST OF REFERENCE SIGNS

100 vehicle
110 evaluation device
120 exterior camera
130 interior camera
140 rear window
150 rear-window wire
160 rear-window heating device
170 control device
180 side window
200 flowchart
210 capture of a first image
220 capture of a second image
230 comparison of the first image with the second image
240 determination of a reduced transparency

1.-13. (canceled)

14. An apparatus for determining a reduced transparency of a window of a vehicle, comprising:
a first image sensor configured to capture a first image of a spatial area outside the vehicle through a window of the vehicle;
a second image sensor configured to capture a second image of the spatial area, other than through the window of the vehicle;
an evaluation device which has an algorithm configured to determine, by comparing the first image with the second image, whether the window has a reduced transparency in comparison with a reference value.

15. The apparatus as claimed in claim 14, having a control device configured to control the first image sensor and the second image sensor in such a way that the first image is captured substantially at the same time as the second image.

16. The apparatus as claimed in claim 15, wherein the control device is configured to activate, before the first image or second image is captured, a vehicle lighting system of the vehicle in order to illuminate the spatial area.

17. The apparatus as claimed in claim 16, wherein the control device is configured to activate the vehicle lighting system if a lighting intensity, identified by a sensor arranged on the vehicle, in surroundings of the vehicle has fallen below a prescribed threshold value.

18. The apparatus as claimed in claim 17, wherein the apparatus further comprises:
a system with an operating mode in which a transparency of the window can be increased; and
wherein the control device is configured to activate the operating mode of the system if the evaluation device has determined that the window has the reduced transparency in comparison with the reference value.

19. The apparatus as claimed in claim 14, wherein the apparatus further comprises:
a system with an operating mode in which a transparency of the window can be increased; and
a control device configured to activate the operating mode of the system if the evaluation device has determined that the window has the reduced transparency in comparison with the reference value.

20. The apparatus as claimed in claim 17, wherein:
the algorithm of the evaluation device is configured to determine, from a plurality of first images captured temporally one after another and from a plurality of second images captured temporally one after another, in each case by comparing in each case one of the first images with in each case one of the second images, whether the window has a reduced transparency in comparison with the reference value; and
wherein the control device is configured to deactivate the operating mode of the system if one of the comparisons has revealed that the transparency substantially corresponds to the reference value.

21. The apparatus as claimed in claim 20, wherein:
the system has a heating device; and
the control device is configured to activate the operating mode such that the heating device generates heat for heating the window.

22. The apparatus as claimed in claim 19, wherein:
the system has a heating device; and
the control device is configured to activate the operating mode such that the heating device generates heat for heating the window.

23. The apparatus as claimed in claim 22, wherein:
the system has a windshield-cleaning device with a windshield wiper and a cleaning-fluid device; and
the control device is configured to activate the operating mode such that the windshield-cleaning device in which at least the windshield wiper is activated.

24. The apparatus as claimed in claim 19, wherein:
the system has a windshield-cleaning device with a windshield wiper and a cleaning-fluid device; and
the control device is configured to activate the operating mode such that the windshield-cleaning device in which at least the windshield wiper is activated.

25. The apparatus as claimed in claim 24, wherein:
the system has a ventilation device,
the control device is configured to activate the operating mode such that the ventilation device supplies air to an interior of the vehicle.

26. The apparatus as claimed in claim 19, wherein:
the system has a ventilation device,
the control device is configured to activate the operating mode such that the ventilation device supplies air to an interior of the vehicle.

27. The apparatus as claimed in claim 19, wherein:
the system has a window regulator,
the control device is configured to activate the operating mode such that the window regulator moves the window into an open state.

28. A vehicle having an apparatus as claimed in claim 14.

29. A method for determining a reduced transparency of a window of a vehicle, comprising:
capturing a first image of a spatial area outside the vehicle through a window of the vehicle using a first image sensor;
capturing of a second image of the spatial area using a second image sensor, other than through the window of the vehicle;
comparing of the first image with the second image, taking into account a reference value, using an algorithm of an evaluation device; and
determining, using the comparison, whether the window has a reduced transparency in comparison with the reference value.

30. A non-transitory storage medium having a computer program with instructions which, when executing by one or more processing devices, performs a method comprising:
obtaining from a first image sensor a first image of a spatial area outside the vehicle through a window of the vehicle;
obtaining from a second image sensor a second image of the spatial area, wherein the second image sensor obtains the second image other than through the window of the vehicle;
comparing of the first image with the second image, taking into account a reference value, using an algorithm; and
determining, using the comparison, whether the window has a reduced transparency in comparison with the reference value.
